(19) United States
(12) Patent Application Publication
(10) Pub. No.: US 2017/0189877 A1
(43) Pub. Date: Jul. 6, 2017

(54) Dual Bed Pyrolysis System and Method

(71) Applicant: Battelle Memorial Institute, Columbus, OH (US)

(72) Inventors: Zia Abdullah, Columbus, OH (US); Michael A. O'Brian, Columbus, OH (US); Slawomir Winecki, Dublin, OH (US); Rachid Taha, Dublin, OH (US)

(21) Appl. No.: 15/313,948

(22) PCT Filed: May 22, 2015
(86) PCT No.: PCT/US2015/032234

§ 371 Date: Nov. 23, 2016

Related U.S. Application Data
(60) Provisional application No. 62/002,779, filed on May 23, 2014.

(51) Int. Cl. B01J 8/38; C10B 49/18; C10B 49/16; B01J 8/18; B01J 8/08

(52) U.S. Cl. CPC B01J 8/388; B01J 8/1872; B01J 8/087; C10B 49/16; C10B 49/18; B01J 2208/00168; B01J 2208/00876

(57) ABSTRACT

A dual bed pyrolysis system may include a falling bed reactor employing a heat carrier particulate to pyrolyze biomass to create a pyrolysis product and a pyrolysis waste product. The dual bed pyrolysis system may also include a fluidized bed reactor. The fluidized bed reactor may accept the pyrolysis waste product including char and heat carrier particulate from the falling bed reactor. The fluidized bed reactor may combust the char in the presence of the heat carrier particulate. The fluidized bed reactor may combust the char to reheat the heat carrier particulate. The reheated heat carrier particulate may be provided to the falling bed reactor to pyrolyze biomass to create a pyrolysis product and a pyrolysis waste product.

### CROSS-REFERENCE TO RELATED APPLICATIONS

This application claims priority to U.S. Provisional Patent Application No. 62/002,779, filed on May 23, 2014, which is incorporated by reference herein in its entirety.

### BACKGROUND

Biomass pyrolysis is conventionally conducted using bubbling fluid beds, circulating fluid bed transport reactors, rotating cone reactors, ablative reactors, or auger reactors. Fluidized bed designs such as bubbling fluid bed reactors and circulating fluid bed reactors may provide high heat transfer rates to the substrate, e.g., biomass, and these high heat transfer rates may result in high yield of bio-oil. A disadvantage of fluidized bed systems is that a significant flow rate of inert gas may be needed, which may lead to undesirable parasitic losses. Other designs, such as rotating cone reactors and auger reactors may not require significant inert gas flow, but mixing between the heat carrier particulate and biomass may not be as effective as with fluidized beds, which may lead to lower reaction yields, e.g., of bio-oil from bio mass pyrolysis. The present application appreciates that efficient biomass pyrolysis may be a challenging endeavor.

### SUMMARY

In one embodiment, a dual bed pyrolysis system is provided. The dual bed pyrolysis system may include a falling bed reactor. The falling bed reactor may include a reactor conduit defining a flow axis. The falling bed reactor may include an inlet operatively coupled to receive a heat carrier particulate into the reactor conduit. The falling bed reactor may include an outlet operatively coupled to direct the heat carrier particulate out of the reactor conduit. The falling bed reactor may include one or more baffles mounted in the reactor conduit, e.g., a plurality of baffles. The dual bed pyrolysis system may also include a fluidized bed reactor. The fluidized bed reactor may include a fluidized bed char combustion chamber. The fluidized bed reactor may include a flow input and a flow output in fluidic communication with the fluidized bed char combustion chamber. The outlet of the falling bed reactor may be operatively coupled to the flow input of the fluidized bed reactor. The flow output of the fluidized bed reactor may be operatively coupled to the inlet of the falling bed reactor.

In another embodiment, a method for pyrolyzing a substrate is provided. The method may include feeding a heat carrier particulate to a gravity-fed baffled conduit. The method may include feeding a pyrolysis substrate to the gravity-fed baffled conduit such that the heat carrier particulate and the pyrolysis substrate mix to form a pyrolysis mixture. The method may include heating the heat carrier particulate and/or the gravity-fed baffled conduit to pyrolyze the pyrolysis substrate in the pyrolysis mixture to form a pyrolysis product mixture and a pyrolysis waste mixture. The pyrolysis waste mixture may include the heat carrier particulate and a coarse char pyrolysis product. The method may include combusting the coarse char pyrolysis product in the presence of the heat carrier particulate to reheat the heat carrier particulate.

### BRIEF DESCRIPTION OF THE DRAWINGS

The accompanying figures, which are incorporated in and constitute a part of the specification, illustrate example methods and apparatuses, and are used merely to illustrate example embodiments.

FIG. 1 depicts an example falling bed reactor.

FIG. 2 depicts an example pyrolysis system that includes an example falling bed reactor and an example fluidized bed.

FIG. 3A is a flow diagram of an example method for pyrolysis using both falling bed pyrolysis and fluidized bed combustion.

FIG. 3B is a flow diagram of an example method for pyrolysis using both falling bed pyrolysis and fluidized bed combustion.

### DETAILED DESCRIPTION

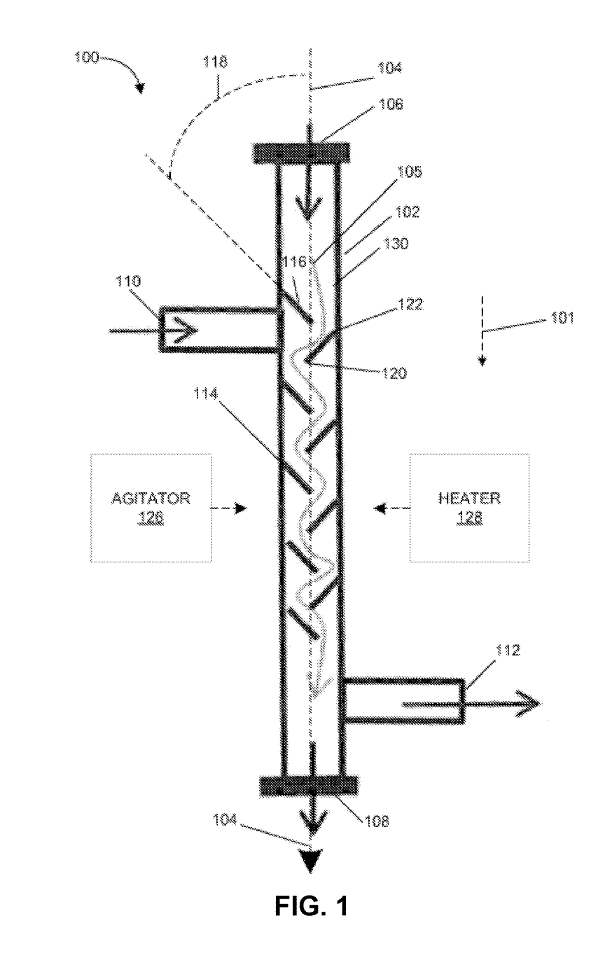

FIG. 1 depicts an example falling bed reactor 100. Falling bed reactor 100 may include a reactor conduit 102 defining a flow axis 104. Flow axis 104 may have a downstream end, indicated by the arrowhead, and an upstream end, indicated by the shaft end of the arrow. Falling bed reactor 100 may include an inlet 106 operatively coupled to receive a heat carrier particulate into reactor conduit 102. Falling bed reactor 100 may also include an outlet 108 operatively coupled to direct the heat carrier particulate out of reactor conduit 102. Falling bed reactor 100 may further include a pyrolysis substrate inlet 110 operatively coupled to receive a pyrolysis substrate into reactor conduit 102. Falling bed reactor 100 may include a pyrolysis product outlet 112 operatively coupled to direct a pyrolysis product out of reactor conduit 102. Falling bed reactor 100 may also include one or more baffles 114, e.g., a plurality of baffles, mounted in reactor conduit 102. Each of the one or more baffles 114 may include a baffle surface 116. At least a portion of each baffle surface 116 may extend downward from reactor conduit 102 to define an oblique angle 118 with respect to flow axis 104.

As used herein, an “oblique angle” is any angle between about horizontal, e.g., about 90° or perpendicular with respect to flow axis 104, and about vertically downward, e.g., about parallel or 0°, e.g., with respect to flow axis 104. In some embodiments, the oblique angle 118 with respect to flow axis 104 may be effective to permit the biomass and/or heat carrier particulate to slide on each baffle surface 116 under the influence of gravity. In some embodiments, oblique angle 118 may be an angle in degrees with respect to flow axis 104 of about 5, 10, 15, 20, 25, 30, 35, 40, 45, 50, 55, 60, 65, 70, 75, 80, or 85, e.g., about 45°, or a range between any two of the preceding values, e.g., between about 20° and about 70°, between 30° and about 60°, between about 40° and about 50°, and the like.

In various embodiments, falling bed reactor 100 may be configured to be mounted such that at least a portion of flow axis 104 is parallel or oblique to a vertically downward direction. Falling bed reactor 100 may be configured to be mounted such that at least a portion of each baffle surface 116 is at oblique angle 118 with respect to the vertically downward direction. Falling bed reactor 100 may be mounted to orient flow axis 104 in a substantially vertically downward direction. In this manner, falling bed reactor 100 may be gravity-fed or gravity operated, at least in part. For example, the pyrolysis substrate may enter falling bed reactor 100 at pyrolysis substrate inlet 110, and the heat carrier particulate may enter falling bed reactor 100 at inlet 106. The pyrolysis substrate and the heat carrier particulate may fall through falling bed reactor 100, and may be intermittently diverted from flow axis 104 by the one or more baffles 114, for example, as indicated by a path 105.

In some embodiments, a cross section of reactor conduit 102 may include a shape that may be one of: polygonal, rounded polygonal, circular, elliptical, rectangular, rounded rectangular, a combination or composite thereof, and the like. For example, reactor conduit 102 may be square in cross section.

In several embodiments, one or both of inlet 106 and outlet 108 may be at an angle with one or both of reactor conduit 102 and flow axis 104, for example, from about substantially parallel with one or both of reactor conduit 102 and flow axis 104 to about substantially perpendicular with one or both of reactor conduit 102 and flow axis 104. One or both of inlet 106 and outlet 108 may be within or emerging from a sidewall of conduit 102 (not shown). Inlet 106 may be operatively coupled to reactor conduit 102 upstream of outlet 108 with respect to flow axis 104. Pyrolysis substrate inlet 110 may be operatively coupled to reactor conduit 102 upstream of pyrolysis product outlet 112 with respect to flow axis 104. Pyrolysis substrate inlet 110 may be operatively coupled to reactor conduit 102 upstream of pyrolysis product outlet 112 with respect to flow axis 104. Pyrolysis substrate inlet 110 may be operatively coupled to reactor conduit 102 at a same level or downstream of pyrolysis product outlet 112 with respect to flow axis 104. Pyrolysis substrate inlet 110 may be coincident with inlet 106. Pyrolysis product outlet 112 may be coincident with inlet 106 or outlet 108.

In various embodiments, one or more baffles 114 may be mounted to place at least a portion of each baffle surface 116 at oblique angle 118 with respect to flow axis 104 such that one or more baffles 114 may form a staggered or alternating pattern in reactor conduit 102. Each baffle in one or more baffles 114 may be mounted to an inside wall 130 of reactor conduit 102 to define a free edge 120 of each baffle surface 116 and a mounted edge 122 of each baffle surface. In some embodiments, one or more baffles 114 may be configured as an alternating sequence of funnels and cones, the funnels aligned with the flow axis 104 and the cones aligned antiparallel to the flow axis 104, each of the funnels and cones may include a free edge 120 at a downstream extremity of each of the funnels and cones. In some embodiments, the staggered or alternating pattern of one or more baffles 114 intersects flow axis 104 to provide a tortuous flow path through one or more baffles 114. Each baffle surface 116 in one or more baffles 114 may be substantially at oblique angle 118 with respect to flow axis 104. For example, oblique angle 118 may be between about 30° and about 60° with respect to flow axis 104 such that for each baffle surface 116, a free edge 120 of baffle surface 116 may be further downstream along flow axis 104 compared to a mounted edge 122 of baffle surface 116.

In several embodiments, falling bed reactor 100 may include an agitator mechanism 126 configured to agitate at least a portion of one or more baffles 114 effective to dislodge a particulate on at least a portion of one or more baffles 114. Falling bed reactor 100 may include a heater 128. Heater 128 may be configured to cause pyrolysis of a substrate in falling bed reactor 100 by heating one or both of falling bed reactor 100 and a heat carrier particulate to be fed into falling bed reactor 100.

As used herein, “downward” means any direction represented by a vector having a non-zero component parallel with respect to a local gravitational acceleration direction. As used herein, “upward” means any direction represented by a vector having a non-zero component antiparallel with respect to the local gravitational acceleration direction. As used herein, “vertical” means parallel or antiparallel with respect to the local gravitational acceleration direction. “Vertically downward” means parallel with respect to the local gravitational acceleration direction, indicated in FIG. 1 by arrow 104. “Vertically upward” means antiparallel with respect to the local gravitational acceleration direction. As used herein, “horizontal” means perpendicular to the local gravitational acceleration direction. In some embodiments, the flow axis 104 of falling bed reactor 100 may be, in degrees from vertical, within about ±30°, ±25°, ±20°, ±15°, ±14°, ±13°, ±12°, ±11°, ±10°, ±9°, ±8°, +7°, +6°, ±5°, ±4°, ±3°, ±2°, ±1°, or ±0.5°.

As used herein, a “particulate” refers to a plurality, collection, or distribution of individual particles. The individual particles in the particulate may have in common one or more characteristics, such as size, density, material composition, heat capacity, particle morphology, and the like. The characteristics of the particles in the particulate may be the same among the particles, or may be characterized by a distribution. For example, particles in a particulate may all be made of the same composition, e.g., a ceramic, a metal, a mineral, a silica, a catalyst, a char, or the like. The characteristics of the particles in the particulate may be a combination of material compositions. For example, particles in a particulate may be mixtures of different compositions, e.g., two or more of: a ceramic, a metal, a mineral, a catalyst, a silica, a char, and the like. In another example, particles in a particulate may be characterized by a distribution of particle sizes, for example, a Gaussian distribution. Particles in a particulate may be characterized by a bimodal distribution of particle size.

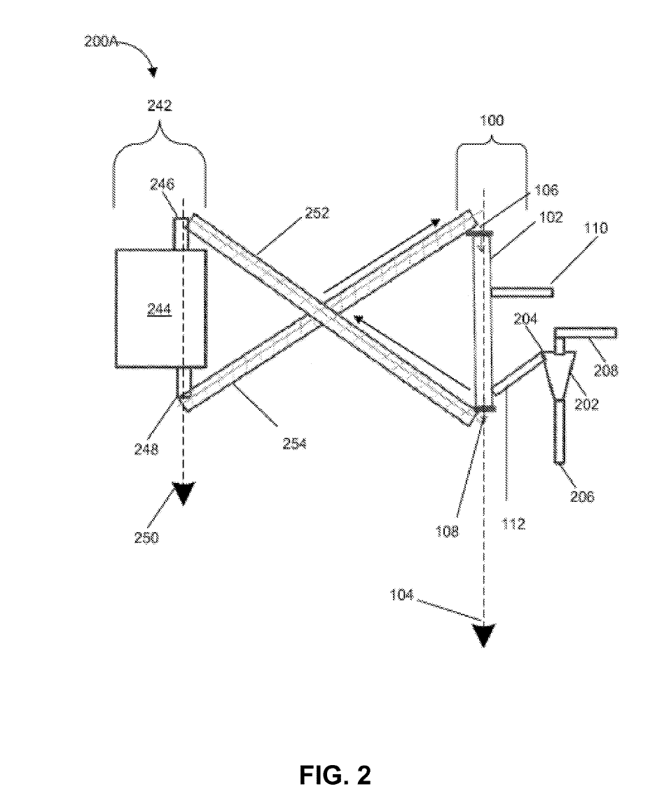

FIG. 2 depicts an example dual bed pyrolysis system 200A. Pyrolysis system 200A may include falling bed reactor 100 and a fluidized bed reactor 202. Falling bed reactor 100 may include a reactor conduit 102 defining a flow axis 104. Flow axis 104 may have a downstream end, indicated by the arrowhead, and an upstream end, indicated by the shaft end of the arrow. Falling bed reactor 100 may include an inlet 106 operatively coupled to receive a heat carrier particulate into reactor conduit 102. Falling bed reactor 100 may also include an outlet 108 operatively coupled to direct the heat carrier particulate out of reactor conduit 102. Falling bed reactor 100 may further include a pyrolysis substrate inlet 110 operatively coupled to receive a pyrolysis substrate into reactor conduit 102. Falling bed reactor 100 may include a pyrolysis product outlet 112 operatively coupled to direct a pyrolysis product out of reactor conduit 102. Falling bed reactor 100 may also include a one or more baffles 114 mounted in reactor conduit 102. Each baffle in one or more baffles 114 may include a baffle surface 116. At least a portion of each baffle surface 116 may be at an oblique angle with respect to flow axis 104, e.g., similar to oblique angle 118 in FIG. 1.

As used herein, a heat carrier particulate suitable for use in the example reactors described herein may include one or more of: a mineral, a glass, a ceramic, a silica, a polymeric composite, a char, an ash, a catalyst, a metal, and the like. The heat carrier particulate may include a mineral, e.g., quartz sand. The heat carrier particulate may include a glass, e.g., silicate glass. The heat carrier particulate may include a ceramic, e.g., an alumina ceramic. The heat carrier particulate may include the char. The heat carrier particulate may include an ash, e.g., carbonates, oxides, sulfates, and the like of one or more of: sodium, potassium, calcium, iron, magnesium, phosphorus, zinc, tin, titanium, sulfur, and the like.

In several embodiments, the particulate catalyst may be used as the heat carrier particulate and the pyrolysis vapor may be catalyzed in situ in the falling bed reactor, producing an upgraded bio-oil vapor in one step, and upgraded bio-oil when condensed. The heat carrier particulate may be in the form of metal shot, for example, steel shot.

In various embodiments, the heat carrier particulate may include one or more of: steel, stainless steel, cobalt (Co), molybdenum (Mo), nickel (Ni), titanium (Ti), tungsten (W), zinc (Zn), antimony (Sb), bismuth (Bi), cerium (Ce), vanadium (V), niobium (Nb), tantalum (Ta), chromium (Cr), manganese (Mn), rhenium (Re), iron (Fe), platinum (Pt), iridium (Ir), palladium (Pd), osmium (Os), rhodium (Rh), ruthenium (Ru), nickel, copper impregnated zinc oxide (Cu/ZnO), copper impregnated chromium oxide (Cu/Cr), nickel aluminum oxide (Ni/Al₂O₃), palladium aluminum oxide (PdAl₂O₃), cobalt molybdenum (CoMo), nickel molybdenum (NiMo), nickel molybdenum tungsten (NiMoW), sulfided cobalt molybdenum (CoMo), sulfided nickel molybdenum (NiMo), a metal carbide, and the like. The heat carrier particulate may include an oxide, carbonate, sulfate, or the like of one or more of the preceding metals.

In some embodiments, the heat carrier particulate may be inert. The heat carrier particulate may include a catalytically active particulate or may include a particulate catalyst. For example, the heat carrier particulate may include particles of one or more of a catalytically active: metal, metal oxide, metal carbonate, metal sulfate, zeolite, char, ash, and the like. The heat carrier particulate may include a recycled or spent particulate catalyst, e.g., a fluid catalytic cracking (FCC) catalyst. The heat carrier particulate may include a spent particulate catalyst, e.g., a spent FCC catalyst. Catalytically active particulates may have various activities. Various FCC catalysts may, e.g., increase cracking of carbon-oxygen, e.g., ether bonds during pyrolysis. For example, catalytic effects of FCC catalysts may include one or more of: increased generation of gaseous, e.g., C₁-C₄ hydrocarbons; increased generation of oxygen-containing species, e.g., H₂O, CO, CO₂, and the like; production of upgraded bio-oil characterized by one or more of decreased viscosity, decreased oxygen content, increased heat value, decreased acid value, decreased hydroxyl value, and the like. Catalytically active char, for example, may lead to increased cracking and/or condensation reactions. Catalytically active ash may have similar effects as FCC catalysts, e.g., increased cracking of carbon-oxygen, e.g., ether bonds during pyrolysis. Effects of catalytically active ash may include one or more effects described for FCC catalysts.

In several embodiments, the heat carrier particulate may include a catalyst and a non-catalyst. A heat carrier particulate including a mixture of a catalyst and a non-catalyst may include a catalyst present in an amount in wt % of at least about one or more of: 15, 20, 25, 30, 35, 40, 45, 50, 55, 60, 65, 70, 75, 80, and 85. A heat carrier particulate including a mixture of a catalyst and a non-catalyst may include a catalyst present in an amount in wt % between any of the preceding values, for example, between about 15 and about 40, or between about 20 and about 80. A heat carrier particulate including a mixture of a catalyst and a non-catalyst may include a catalyst present in an amount at least about 1 wt %. A heat carrier particulate including a mixture of a catalyst and a non-catalyst may include a catalyst present in an amount up to about 99 wt %.

In various embodiments, the heat carrier particulate may include an average particle size in μm of about one or more of: 20 μm, 30 μm, 40 μm, 50 μm, 75 μm, 0.1 mm, 0.25 mm, 0.5 mm, 0.75 mm, 1 mm, 2 mm, 3 mm, 4 mm, 5 mm, 7.5 mm, and 10 mm; or a range between any two of the preceding values, for example, between about 20 μm and about 10 mm, between about 50 μm and about 0.75 mm, and the like.

Fluidized bed reactor 242 may include a fluidized bed char combustion chamber 244. Fluidized bed reactor 242 may also include a flow input 246 and a flow output 248 in fluidic communication with fluidized bed char combustion chamber 244. In some embodiments, flow input 246 and flow output 248 may be on opposite sides of fluidized bed char combustion chamber 244 to define a flow path 250 extending from flow input 246, into fluidized bed char combustion chamber 244, and to flow output 248. Flow input 246 may be located upstream of flow output 248 with respect to flow axis 250. Further with respect to pyrolysis system 200A, outlet 108 of falling bed reactor 100 may be operatively coupled to flow input 246 of fluidized bed reactor 242. Also, flow output 248 of fluidized bed reactor 242 may be operatively coupled to inlet 106 of falling bed reactor 100.

In various embodiments, outlet 108 of falling bed reactor 100 may be operatively coupled to flow input 246 of fluidized bed reactor 242 via an auger or conveyor 252. Flow output 248 of fluidized bed reactor 242 may be operatively coupled to inlet 106 of falling bed reactor 100 via an auger or conveyor 254. In another embodiment, the falling bed reactor 100 may be physically lowered in elevation relative to fluidized bed reactor 242 such that the inlet 106 of the falling bed reactor 100 is lower in elevation than the outlet 248 of the fluidized bed reactor 242. In this embodiment flow output 248 of fluidized bed reactor 242 may be operatively coupled to inlet 106 of falling bed reactor 100 via a simple downward sloping pipe or duct 254. In another embodiment, the falling bed reactor 100 may be physically raised in elevation relative to fluidized bed reactor 242 such that the outlet 108 of the falling bed reactor 100 is higher in elevation than the inlet 246 of the fluidized bed reactor 242. In this embodiment flow output 108 of falling bed reactor 100 may be operatively coupled to inlet 606 of fluidized bed reactor 242 via a simple downward sloping pipe or duct 252.

In some embodiments, dual bed pyrolysis system 200A may include a fine particulate separator 202. An input 204 of fine particulate separator 202 may be operatively coupled to pyrolysis product outlet 112 of falling bed reactor 100. Fine particulate separator 202 may include a particulate outlet 206 and a gas or vapor outlet 208. For example, fine particulate separator 202 may include one or more of: a settling chamber, a baffle chamber, a cyclonic particle separator, an electrostatic precipitator, a filter, a scrubber, and the like. Fine particulate separator 202 may separate, for example, fine char produced during the pyrolysis of the biomass in falling bed reactor 100. The fine char may be entrained in pyrolysis gas exiting falling bed reactor 100 via pyrolysis product outlet 112. Large char particulates that may be too heavy or too large to be entrained in pyrolysis gas exiting falling bed reactor 100 may exit at outlet 108 along with spent heat carrier particulate. Auger or conveyor or downward sloping pipe 252 may transport the spent heat carrier particulate and the large char particulates to flow input 246 of fluidized bed reactor 242, and into fluidized bed char combustion chamber 244. The large char particulates may be combusted in fluidized bed char combustion chamber 244. Combustion of the large char particulates in fluidized bed char combustion chamber 244 may dispose of the large char particulates. Combustion of the large char particulates in fluidized bed char combustion chamber 244 may also heat the spent heat carrier particulate to provide reheated heat carrier particulate suitable for further pyrolysis. The reheated heat carrier particulate produced by combustion of the large char particulates in fluidized bed char combustion chamber 244 may exit fluidized bed char combustion chamber 244 at flow output 248. Flow output 248 of fluidized bed reactor 242 may be operatively coupled to inlet 106 of falling bed reactor 100 via auger or conveyor or downward sloping pipe 254. Auger or conveyor 254 or the force of gravity in a downward sloping pipe may transport the reheated heat carrier particulate from flow output 248 of fluidized bed reactor 242 to inlet 106 to be combined with biomass for further pyrolysis in falling bed reactor 100.

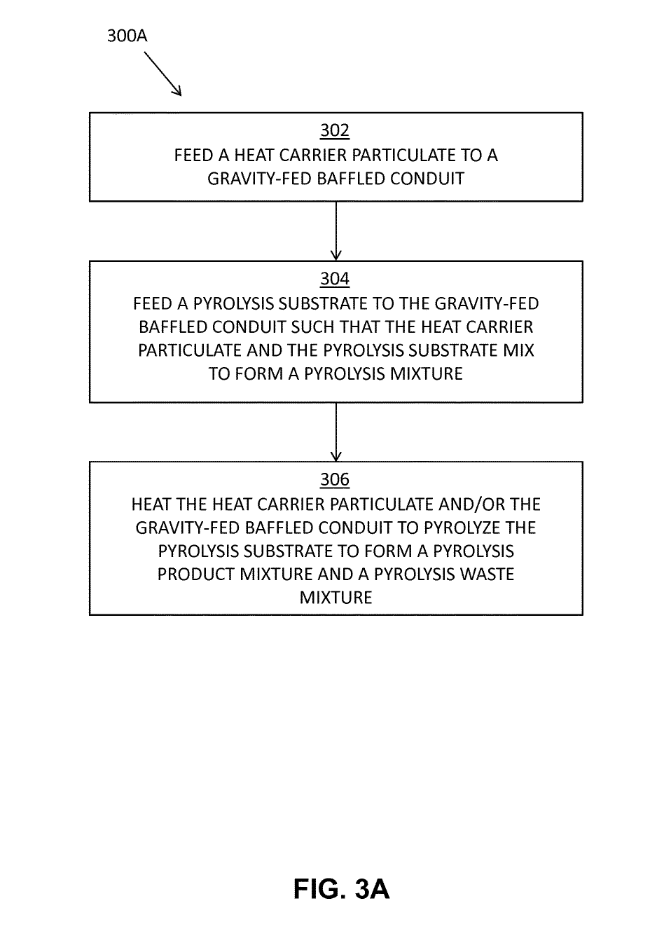

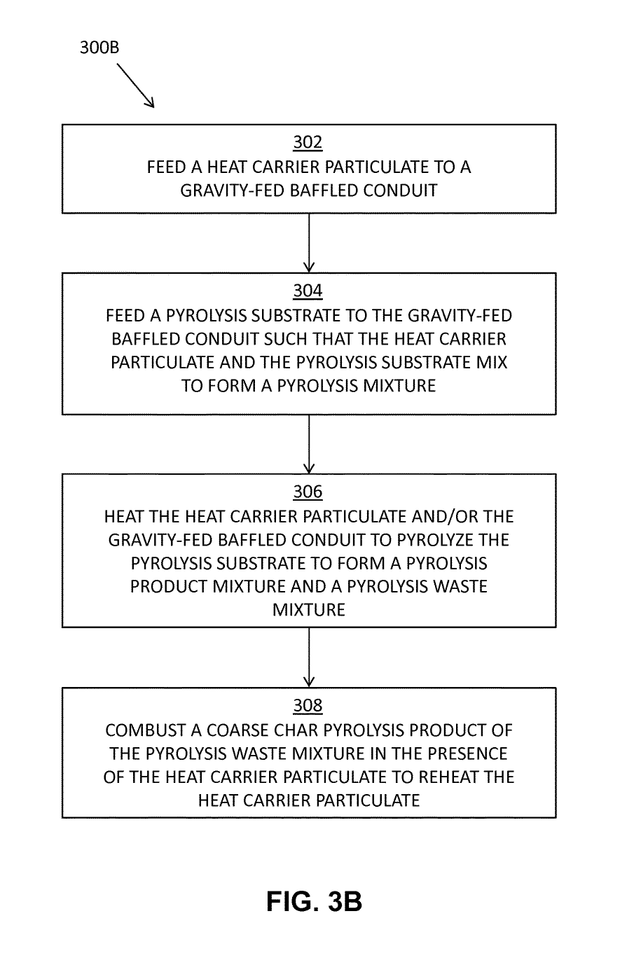

FIG. 3A shows a flow diagram of an example method 300A for pyrolysis using both falling bed pyrolysis and fluidized bed combustion. Method 300A may include 302 feeding a heat carrier particulate to a gravity-fed baffled conduit. Method 300A may include 304 feeding a pyrolysis substrate to the gravity-fed baffled conduit such that the heat carrier particulate and the pyrolysis substrate mix to form a pyrolysis mixture. Method 300A may include 306 heating the heat carrier particulate and/or the gravity-fed baffled conduit to pyrolyze the pyrolysis substrate in the pyrolysis mixture to form a pyrolysis product mixture and a pyrolysis waste mixture. The pyrolysis waste mixture may include the heat carrier particulate and a coarse char pyrolysis product. The method may optionally include 308 combusting the coarse char pyrolysis product in the presence of the heat carrier particulate to reheat the heat carrier particulate.

FIG. 3B shows a flow diagram of an example method 300B for pyrolysis using both falling bed pyrolysis and fluidized bed combustion. Method 300B may include 302 feeding a heat carrier particulate to a gravity-fed baffled conduit. Method 300B may include 304 feeding a pyrolysis substrate to the gravity-fed baffled conduit such that the heat carrier particulate and the pyrolysis substrate mix to form a pyrolysis mixture. Method 300B may include 306 heating the heat carrier particulate and/or the gravity-fed baffled conduit to pyrolyze the pyrolysis substrate in the pyrolysis mixture to form a pyrolysis product mixture and a pyrolysis waste mixture. The pyrolysis waste mixture may include the heat carrier particulate and a coarse char pyrolysis product. Compared to method 300A, method 300B may include 308 combusting the coarse char pyrolysis product in the presence of the heat carrier particulate to reheat the heat carrier particulate.

In various embodiments, a dual bed pyrolysis system 200A is provided. Dual bed pyrolysis system 200A may include a falling bed reactor 100. Falling bed reactor 100 may include a reactor conduit 102 defining a flow axis 104. Falling bed reactor 100 may include an inlet 106 operatively coupled to receive a heat carrier particulate into the reactor conduit 102. Falling bed reactor 100 may include an outlet 108 operatively coupled to direct the heat carrier particulate out of the reactor conduit 102. Falling bed reactor 100 may include one or more baffles 114 mounted in reactor conduit 102. Dual bed pyrolysis system 200A may also include a fluidized bed reactor 242. Fluidized bed reactor 242 may include a fluidized bed char combustion chamber 244. Fluidized bed reactor 242 may include a flow input 246 and a flow output 248 in fluidic communication with fluidized bed char combustion chamber 244. Outlet 108 of falling bed reactor 100 may be operatively coupled to flow input 246 of fluidized bed reactor 242. Flow output 248 of fluidized bed reactor 242 may be operatively coupled to inlet 106 of falling bed reactor 100.

In some embodiments, falling bed reactor 100 may include a pyrolysis substrate inlet 110 operatively coupled to receive a pyrolysis substrate into reactor conduit 102. Falling bed reactor 100 may include a pyrolysis product outlet 112 operatively coupled to direct a pyrolysis product out of reactor conduit 102.

In several embodiments, each baffle in one or more baffles 114 may include a baffle surface 116. At least a portion of each baffle surface 116 may be at an oblique angle 118 with respect to flow axis 104.

In some embodiments, dual bed pyrolysis system 200A may include an auger or conveyor or downward sloping pipe 252. Outlet 108 of falling bed reactor 100 may be operatively coupled to flow input 246 of fluidized bed reactor 242 via auger or conveyor or downward sloping pipe 252. Dual bed pyrolysis system 200A may include an auger or conveyor or downward sloping pipe 254. Flow output 248 of fluidized bed reactor 242 may be operatively coupled to inlet 106 of falling bed reactor 100 via auger or conveyor or downward sloping pipe 254.

In some embodiments, dual bed pyrolysis system 200A may include a fine particulate separator 202. An input 204 of the fine particulate separator 202 may be operatively coupled to pyrolysis product outlet 112 of falling bed reactor 100. The fine particulate separator 202 may include a particulate outlet 206 and a gas or vapor outlet 208. The fine particulate separator 202 may include one or more of: a settling chamber, a baffle chamber, a cyclonic particle separator, an electrostatic precipitator, a filter, a scrubber, and the like.

In several embodiments, falling bed reactor 100 may be configured to be mounted such that at least a portion of flow axis 104 may be parallel or oblique to a vertically downwards direction. Falling bed reactor 100 may be configured to be mounted such that at least a portion of each baffle surface 116 may be at oblique angle 118 with respect to the vertically downwards direction. Falling bed reactor 100 may be mounted to orient the flow axis 104 in a substantially vertically downwards direction.

In various embodiments, a cross section of reactor conduit 102 may include a shape that is one of: polygonal, rounded polygonal, circular, elliptical, rectangular, rounded rectangular, square, rounded square, a combination or composite thereof, and the like. For example, the cross section of the reactor conduit 102 may be square.

In some embodiments, one or both of inlet 106 and outlet 108 may be at an any angle with one or both of reactor conduit 102 and flow axis 104, for example, from about substantially parallel with one or both of reactor conduit 102 and flow axis 104 to about substantially perpendicular with one or both of reactor conduit 102 and flow axis 104. One or both of inlet 106 and outlet 108 may be within or emerging from a sidewall of conduit 102. Inlet 106 may be operatively coupled to reactor conduit 102 upstream of outlet 108 with respect to flow axis 104.

In several embodiments, inlet 106 may be operatively coupled to receive a pyrolysis substrate into the reactor conduit 102. Outlet 108 may be operatively coupled to direct a pyrolysis product out of the reactor conduit 102.

In some embodiments, the dual bed pyrolysis system 200A may include a pyrolysis substrate inlet 110 operatively coupled to receive a pyrolysis substrate into the reactor conduit 102. A pyrolysis product outlet 112 may be included and may be operatively coupled to direct a pyrolysis product out of the reactor conduit 102.

In several embodiments, a fine particulate separator 202 may be included. An input 204 of the fine particulate separator 202 may be operatively coupled to the pyrolysis product outlet 112 of the falling bed reactor 100. The fine particulate separator 202 may include a particulate outlet 206 and a gas or vapor outlet 208.

In several embodiments, pyrolysis substrate inlet 110 may be operatively coupled to reactor conduit 102 upstream of pyrolysis product outlet 112 with respect to flow axis 104. Pyrolysis substrate inlet 110 may be operatively coupled to reactor conduit 102 upstream of pyrolysis product outlet 112 with respect to flow axis 104. Pyrolysis substrate inlet 110 may be operatively coupled to reactor conduit 102 at a same level or downstream of pyrolysis product outlet 112 with respect to flow axis 104. Pyrolysis substrate inlet 110 may be coincident with inlet 106. Pyrolysis product outlet 112 may be coincident with inlet 106 or outlet 108.

In various embodiments, the one or more baffles 114 may extend from an inside wall 130 of the reactor conduit 102 into the reactor conduit 102. For example, the one or more baffles 114 may extend from the inside wall 130 to define a cantilevered geometry in the reactor conduit 102. The one or more baffles 114 may extend across at least a portion of the reactor conduit 102 between a first portion of the inside wall 130 and a second portion of the inside wall 130. Each of the one or more baffles 114 may include a form of one or more of: a rod, a plate, a screen, a protrusion, a static-mixer geometry, and the like. Each of the one or more baffles 114 may include a form of a rod. The rod may include a cross-sectional geometry that is at least in part rectangular, rounded rectangular, square, rounded square, polygonal, rounded polygonal, circular, elliptical, a combination or composite thereof, and the like.

In some embodiments, each of the one or more baffles 114 may include a baffle surface 116. The baffle surface 116 may be positioned to intersect at least a portion of the reactor conduit 102 with respect to the flow axis 104. At least a portion of the baffle surface 116 may include a geometry that is one or more of flat and convex. At least a portion of the baffle surface 116 may be horizontal with respect to the flow axis 104. At least a portion of the baffle surface 116 may be at an oblique angle 118 with respect to the flow axis 104.

In several embodiments, one or more baffles 114 may be mounted to place at least the portion of each baffle surface 116 at oblique angle 118 with respect to flow axis 104 such that one or more baffles 114 form a staggered or alternating pattern in reactor conduit 102. The staggered or alternating pattern of one or more baffles 114 may intersect flow axis 104 to provide a tortuous flow path through one or more baffles 114. Each baffle in one or more baffles 114 may be mounted to an inside wall 130 of reactor conduit 102 to define a free edge 120 of each baffle surface 116 and a mounted edge 122 of each baffle surface 116. Each baffle surface 116 in one or more baffles 114 may be substantially at oblique angle 118 with respect to flow axis 104. Oblique angle 118 may be between about 30° and about 60° with respect to flow axis 104 such that for each baffle surface 116, a free edge 120 of baffle surface 116 may be further downstream along flow axis 104 compared to a mounted edge 122 of baffle surface 116.

In various embodiments, dual bed pyrolysis system 200A may include an agitator mechanism 126 configured to agitate at least a portion of one or more baffles 114 effective to dislodge a particulate on at least a portion of one or more baffles 114. A heater 128 may be configured to cause pyrolysis of a substrate in falling bed reactor 100 by heating one or both of falling bed reactor 100 and a heat carrier particulate to be fed into falling bed reactor 100.

In various embodiments, dual bed pyrolysis system 200A may be configured to employ the heat carrier particulate. The heat carrier particulate may be, for example, a mixture of one or more of: a metal; a glass; a ceramic; a mineral; a char; a silica; a catalyst; and a polymeric composition, for example, a mixture of a catalyst; a sand; a char; and the like. For example, the heat carrier particulate may be sand. The heat carrier particulate may include a particulate catalyst. For example, the heat carrier particulate may include a fluid catalytic cracking (FCC) catalyst. The heat carrier particulate may include a spent particulate catalyst. For example, the heat carrier particulate may include a spent FCC catalyst.

In various embodiments, a method 300A for pyrolyzing a substrate is provided. The method may include 302 feeding a heat carrier particulate to a gravity-fed baffled conduit. The method may include 304 feeding a pyrolysis substrate to the gravity-fed baffled conduit such that the heat carrier particulate and the pyrolysis substrate mix to form a pyrolysis mixture. The method may include 306 heating the heat carrier particulate and/or the gravity-fed baffled conduit to pyrolyze the pyrolysis substrate in the pyrolysis mixture to form a pyrolysis product mixture and a pyrolysis waste mixture. The pyrolysis waste mixture may include the heat carrier particulate and a coarse char pyrolysis product. The method may optionally include 308 combusting the coarse char pyrolysis product in the presence of the heat carrier particulate to reheat the heat carrier particulate.

In several embodiments, the method may include feeding the reheated heat carrier particulate to the gravity-fed baffled conduit. The method may include directing the heat carrier particulate and the coarse char pyrolysis product out of the gravity-fed baffled conduit prior to combusting the coarse char pyrolysis product in the presence of the heat carrier particulate to reheat the heat carrier particulate.

In some embodiments, the pyrolysis product mixture may include a gas or vapor pyrolysis product and a fine char pyrolysis product. The method may include directing the gas or vapor pyrolysis product and the fine char pyrolysis product out of the gravity-fed baffled conduit. The method may include directing the gas or vapor pyrolysis product and the fine char pyrolysis product out of the gravity-fed baffled conduit at the same level as the heat carrier particulate and the coarse char pyrolysis product. The method may include directing the gas or vapor pyrolysis product and the fine char pyrolysis product out of the gravity-fed baffled conduit upstream compared to the heat carrier particulate and the coarse char pyrolysis product. The method may include directing the gas or vapor pyrolysis product and the fine char pyrolysis product out of the gravity-fed baffled conduit downstream compared to the heat carrier particulate and the coarse char pyrolysis product. The method may include directing the heat carrier particulate and the coarse char pyrolysis product out of the gravity-fed baffled conduit. The method may include feeding the heat carrier particulate to the gravity-fed baffled conduit including feeding the heat carrier particulate and the pyrolysis substrate at the same level of the gravity-fed baffled conduit. The method may include feeding the heat carrier particulate to the gravity-fed baffled conduit including feeding the heat carrier particulate to the gravity-fed baffled conduit upstream of the pyrolysis substrate. The method may include feeding the heat carrier particulate to the gravity-fed baffled conduit including feeding the heat carrier particulate to the gravity-fed baffled conduit downstream of the pyrolysis substrate.

In several embodiments, the pyrolysis product mixture may include a gas or vapor pyrolysis product and a fine char pyrolysis product. The method may include directing the gas or vapor pyrolysis product and the fine char pyrolysis product out of the gravity-fed baffled conduit. The method may include separating the gas or vapor pyrolysis product from the fine char pyrolysis product.

In various embodiments, the heat carrier particulate may include a mixture of one or more of: a metal; a glass; a ceramic; a mineral; a char; a silica; a catalyst; and a polymeric composition, for example, a mixture of a catalyst; a sand; a char; and the like. For example, the heat carrier particulate may be sand. The heat carrier particulate may include a particulate catalyst. For example, the heat carrier particulate may include a fluid catalytic cracking (FCC) catalyst. The heat carrier particulate may include a spent particulate catalyst. For example, the heat carrier particulate may include a spent FCC catalyst.

### Prophetic Example 1

Heated spherical steel shot, about 1 mm in diameter, may be added via inlet 106 into reactor conduit 102. Ground particulate bio mass (e.g., a mixture of corn stover and wood particulate) may be added via pyrolysis substrate inlet 110 into reactor conduit 102. The reactor conduit 102 and the steel shot may be heated to a desired pyrolysis temperature, e.g., 500° C. The heated steel shot and the bio mass may fall through the one or more baffles 114 mounted in reactor conduit 102. The heated steel shot and the bio mass may mix, and the bio mass may pyrolyze to form a pyrolysis mixture including gas or vapor of bio-oil, bio char, and the heated steel shot. A mixture of fine bio char and the gas or vapor of bio-oil may be collected at pyrolysis product outlet 112. A mixture of coarse bio char and the steel shot may be collected at outlet 108. The falling bed reactor described in this Example may exhibit effective mixing between the steel shot heat carrier particulate and the bio mass, similar to the mixing observed in fluidized bed reactors. The falling bed reactor described in this Example may also operate without needing inert gas.

### Example 2

A dual bed reactor was constructed according to the design of the dual bed pyrolysis system 200A. Heated sand was added via inlet 106 into reactor conduit 102. Particulate bio mass was added via pyrolysis substrate inlet 110 into reactor conduit 102. The reactor conduit 102 and the sand were heated to between about 400° C. and about 800° C. The sand and the bio mass fell through the one or more baffles 114 mounted in reactor conduit 102. The sand and the bio mass mixed, and the bio mass pyrolyzed to form a pyrolysis mixture including vaporized bio-oil, bio char, and the heated sand. A mixture of fine bio char entrained in the bio-oil vapor was collected at pyrolysis product outlet 112. A mixture of coarse bio char and the sand was collected at outlet 108. The mixture of coarse bio char and the sand was transported via auger 252 to flow input 246 of fluidized bed reactor 242, and into fluidized bed char combustion chamber 244. The coarse bio char was combusted in the fluidized bed char combustion chamber 244 at a temperature of between 400° C. to 800° C. Combusting the coarse bio char in the fluidized bed char combustion chamber 244 heated the sand to a temperature of about 400° C. to 800° C. The reheated sand exited fluidized bed char combustion chamber 244 at flow output 248. The reheated sand was transported by auger 254 from flow output 248 of fluidized bed reactor 242 to inlet 106 and combined with biomass for further pyrolysis in falling bed reactor 100. The dual bed reactor system of this Example was operated at a biomass input rate of about 1 ton per 24 h, producing about 50% to 75% of bio-oil yield per day on a dry mass basis.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

The various aspects and embodiments disclosed herein are for purposes of illustration and are not intended to be limiting, with the true scope and spirit being indicated by the following claims.

1. A dual bed pyrolysis system, comprising:
a falling bed reactor, comprising:
a reactor conduit defining a flow axis;
an inlet operatively coupled to receive a heat carrier particulate into the reactor conduit;
an outlet operatively coupled to direct the heat carrier particulate out of the reactor conduit;
one or more baffles mounted in the reactor conduit; and
a fluidized bed reactor, comprising:
a fluidized bed char combustion chamber; and
a flow input and a flow output in fluidic communication with fluidized bed char combustion chamber;
wherein:
the outlet of the falling bed reactor is operatively coupled to the flow input of the fluidized bed reactor; and
the flow output of the fluidized bed reactor is operatively coupled to the inlet of the falling bed reactor.

2. The dual bed pyrolysis system of claim 1, further comprising one or more of:
a first auger or conveyor or downward sloping pipe, the outlet of falling bed reactor being operatively coupled to the flow input of the fluidized bed reactor via the first auger or conveyor or downward sloping pipe; and
a second auger or conveyor or downward sloping pipe, the flow output of the fluidized bed reactor being operatively coupled to the inlet of the falling bed reactor via the second auger or conveyor or downward sloping pipe.

3. (canceled)

4. (canceled)

5. (canceled)

6. The dual bed pyrolysis system of claim 1, the falling bed reactor being mounted to orient the flow axis in a substantially vertically downwards direction.

7. (canceled)

8. (canceled)

9. The dual bed pyrolysis system of claim 1, the inlet being operatively coupled to the reactor conduit upstream of the outlet with respect to the flow axis.

10. (canceled)

11. (canceled)

12. The dual bed pyrolysis system of claim 1, further comprising:
a pyrolysis substrate inlet operatively coupled to receive a pyrolysis substrate into the reactor conduit; and
a pyrolysis product outlet operatively coupled to direct a pyrolysis product out of the reactor conduit.

13. (canceled)

14. (canceled)

15. (canceled)

16. (canceled)

17. The dual bed pyrolysis system of claim 12, one or more of:
the pyrolysis substrate inlet being coincident with the inlet; and
the pyrolysis product outlet being coincident with the inlet or the outlet.

18. (canceled)

19. (canceled)

20. (canceled)

21. (canceled)

22. (canceled)

23. (canceled)

24. (canceled)

25. (canceled)

26. (canceled)

27. The dual bed pyrolysis system of claim 1, the one or more baffles extending from an inside wall of the reactor conduit into the reactor conduit, each of the one or more baffles comprising a baffle surface, at least a portion of the baffle surface being at an oblique angle with respect to the flow axis, the one or more baffles being mounted to place at least the portion of each baffle surface at the oblique angle with respect to the flow axis such that the one or more baffles form a staggered or alternating pattern in the reactor conduit.

28. (canceled)

29. (canceled)

30. The dual bed pyrolysis system of claim 1, the one or more baffles extending from an inside wall of the reactor conduit into the reactor conduit, each of the one or more baffles comprising a baffle surface, at least a portion of the baffle surface being at an oblique angle with respect to the flow axis, the oblique angle being between about 30° and about 60° with respect to the flow axis such that for each baffle surface, a free edge of the baffle surface is further downstream along the flow axis compared to a mounted edge of the baffle surface.

31. (canceled)

32. The dual bed pyrolysis system of claim 1, further comprising an agitator mechanism configured to agitate at least a portion of the one or more baffles effective to dislodge a particulate on at least a portion of the one or more baffles.

33. The dual bed pyrolysis system of claim 1, further comprising a heater configured to cause pyrolysis of a substrate in the falling bed reactor by heating one or both of the falling bed reactor and a heat carrier particulate to be fed into the falling bed reactor.

34. (canceled)

35. (canceled)

36. (canceled)

37. (canceled)

38. (canceled)

39. (canceled)

40. (canceled)

41. A method for pyrolyzing a substrate, comprising:
feeding a heat carrier particulate to a gravity-fed baffled conduit;
feeding a pyrolysis substrate to the gravity-fed baffled conduit such that the heat carrier particulate and the pyrolysis substrate mix to form a pyrolysis mixture; and
heating the heat carrier particulate and/or the gravity-fed baffled conduit to pyrolyze the pyrolysis substrate in the pyrolysis mixture to form a pyrolysis product mixture and a pyrolysis waste mixture, the pyrolysis waste mixture comprising the heat carrier particulate and a coarse char pyrolysis product.

42. The method of claim 41, further comprising one or more of:
combusting the coarse char pyrolysis product in the presence of the heat carrier particulate to reheat the heat carrier particulate;
feeding the reheated heat carrier particulate to the gravity-fed baffled conduit; and
directing the heat carrier particulate and the coarse char pyrolysis product out of the gravity-fed baffled conduit prior to combusting the coarse char pyrolysis product in the presence of the heat carrier particulate to reheat the heat carrier particulate.

43. (canceled)

44. (canceled)

45. The method of claim 41, the pyrolysis product mixture comprising a gas or vapor pyrolysis product and a fine char pyrolysis product, further comprising one or more of:
directing the gas or vapor pyrolysis product and the fine char pyrolysis product out of the gravity-fed baffled conduit;
directing the gas or vapor pyrolysis product and the fine char pyrolysis product out of the gravity-fed baffled conduit at the same level as the heat carrier particulate and the coarse char pyrolysis product;
directing the gas or vapor pyrolysis product and the fine char pyrolysis product out of the gravity-fed baffled conduit upstream compared to the heat carrier particulate and the coarse char pyrolysis product; and
directing the gas or vapor pyrolysis product and the fine char pyrolysis product out of the gravity-fed baffled conduit downstream compared to the heat carrier particulate and the coarse char pyrolysis product.

46. (canceled)

47. (canceled)

48. (canceled)

49. The method of claim 41, further comprising one of:
directing the heat carrier particulate and the coarse char pyrolysis product out of the gravity-fed baffled conduit;
feeding the heat carrier particulate to the gravity-fed baffled conduit comprising feeding the heat carrier particulate and the pyrolysis substrate at the same level of the gravity-fed baffled conduit;
feeding the heat carrier particulate to the gravity-fed baffled conduit comprising feeding the heat carrier particulate to the gravity-fed baffled conduit upstream of the pyrolysis substrate; and
feeding the heat carrier particulate to the gravity-fed baffled conduit comprising feeding the heat carrier particulate to the gravity-fed baffled conduit downstream of the pyrolysis substrate.

50. (canceled)

51. (canceled)

52. (canceled)

53. The method of claim 41, the pyrolysis product mixture comprising a gas or vapor pyrolysis product and a fine char pyrolysis product, the method further comprising:
directing the gas or vapor pyrolysis product and the fine char pyrolysis product out of the gravity-fed baffled conduit; and
separating the gas or vapor pyrolysis product from the fine char pyrolysis product.

54. The method of claim 41, the heat carrier particulate comprising one or more of: a metal, a glass, a ceramic, a mineral, a silica, a catalyst, a char, an ash, and a polymeric composite.

55. The method claim 41, the heat carrier particulate comprising a catalyst and one or more of: a metal, a glass, a ceramic, a mineral, a silica, a char, an ash, and a polymeric composite, wherein the catalyst is present in the heat carrier particulate in an amount of between about 1 wt % and about 99.5 wt %, or between about 20 wt % and about 80 wt %.

56. (canceled)

57. The method of claim 41, the heat carrier particulate comprising one or more of sand and a particulate catalyst.

58. (canceled)

59. The method of claim 41, the heat carrier particulate comprising an average particle size of between about 50 μm to about 0.75 mm, or between about 20 μm to about 10 mm.

60. (canceled)

61. The method of claim 41, the heat carrier particulate comprising a particulate catalyst, further comprising catalyzing a pyrolysis vapor in situ in the falling bed reactor to produce an upgraded bio-oil vapor.
